(19) United States
(12) Patent Application Publication
(10) Pub. No.: US 2012/0106787 A1
(43) Pub. Date: May 3, 2012

(54) APPARATUS AND METHODS FOR ANALYSING GOODS PACKAGES

(75) Inventors: Dmitry Nechiporenko, Singapore (SG); Andrew Conley, Singapore (SG)

(73) Assignee: AZIMUTH INTELLECTUAL PRODUCTS PTE LTD, Singapore (SG)

(21) Appl. No.: 13/260,912

(22) PCT Filed: Dec. 8, 2009
(86) PCT No.: PCT/SG2009/000472

§ 371 Date: Jan. 3, 2012

(30) Foreign Application Priority Data
Mar. 31, 2009 (SG) PCT/SG2009/000108

(51) Int. Cl. G06K 9/46

(52) U.S. Cl. 382/103

(57) ABSTRACT

An apparatus for constructing a data model of a goods package from a series of images, one of the series of images comprising an image of the goods package, comprises a processor and a memory for storing one or more routines. When the one or more routines are executed under control of the processor the apparatus extracts element data from goods package elements in the series of images and constructs the data model by associating element data from a number of visible sides of the goods package with the goods package. The apparatus may also analyse a candidate character string read in an OCR process from one of the series of images of the goods package. The apparatus may also analyse a barcode read from an image of a goods package.

The invention relates to an apparatus and method for constructing a data model of a goods package from a series of images, one of the series of images comprising an image of the goods package. The invention also relates to an apparatus and method for analysing a candidate character string read in an OCR process from an image of a goods package. The invention also relates to an apparatus and method for analysing a barcode read from an image of a goods package. The invention also extends to machine- (computer-) readable media having stored thereon machine-readable instructions for executing, in a machine, the aforementioned methods.

The invention has particular, but not exclusive application for analysing the contents on a pallet to facilitate automated warehouse management. Exemplary illustrated techniques comprise of a “Neural Cargo Analyser”.

In logistics, inbound and outbound cargo control is typically an error-prone, expensive and time-consuming process requiring a substantial amount of work maintaining WMS (Warehouse Management Systems) and ERPs (Enterprise Resource Planning Systems). The results of this cargo control are often hard to evaluate and contain far too little data to be of any great assistance to the warehouse management process.

In a typical current scenario, inbound goods are checked with three main steps:
1) Determine what has arrived and from which supplier
2) Count how many cases have arrived, which articles and what quantities
3) Determination of damaged or missing goods

For outbound goods the steps are as follows:
4) Count how many cases have arrived, which articles and what quantities
5) Determination of damaged or missing goods

Steps 1) ‘Determining what has arrived and from which supplier’ and 3) ‘Determination of damaged or missing goods’ are principally manual activities and therefore are error prone processes. Typically a warehouse worker visually inspects boxes looking for logos and part numbers and then enters this data onto a paper form. At some later time, this form will be manually keyed into some type of spreadsheet or management system. There is a high degree of data loss as well as inaccuracy.

Counting ‘how many cases have arrived, which articles and what quantities’ in step 2) is typically done by warehouse workers using manual barcode scanners. Barcodes generally include information on articles, quantities, serial numbers, order numbers, and carton/pallet IDs. In some cases it may include country of origin and some supplementary information for vendor's IT system. The results of this data are often connected directly to a WMS or ERP system.

These existing methods have several prominent problems:
The manually collected data is unreliable and thus has a low confidence rate.
Barcode scanners must be operated in a rigorous sequential manner. All barcodes must be collected in ‘the proper’ order. One missed scan could propagate an error throughout the entire sequence of barcodes.
There is no way to accurately correlate the barcode data with manually collected paper data.
Barcode data can easily be corrupted by scratches on the labels or presence of foreign material.

Some warehouses have implemented RFID (Radio Frequency Identification Device) tags as an alternative to manual tracking. This method is much more accurate, than barcode-reading combined with paper processing. It also much faster, as it only takes the truck driver with the pallet to pass before reading portal, to acquire the whole information on the chips from the pallet. However this method also has several disadvantages:
Cost: The cost of the RFID labels and reading equipment is very high; much higher than normal barcodes. This adds substantially to the cost of each and every tagged carton.
Robustness: RF tags are sensitive to temperature, humidity, and magnetic fields. This can be highly problematic in the typical ‘uncontrolled’ environment of a warehouse.
Accessibility: RFID cannot be used in dense containers or within materials such as metals and liquids. These materials shield the radio waves resulting in a increased probability of errors. Such a condition forces the operator to revert back to the manual method which defeats the initial purpose.

Other optical recognition systems are available which allow a warehouse manager to recognise barcodes on, for example, goods cartons on a pallet (or text/colour information), and use this information as ‘pallet content’. However, this is still not ideal because there is ambiguity as to which barcode (or serial number or other carton data value) belongs to which carton. Also, if a carton barcode is damaged there is no provision for error recovery.

And even when it's known that should be, say, 20 cartons in a pallet, there is no guarantee that, having 20 carton data entries, some of them were not taken from the same carton (like in case each carton has labels on front and rear side and both sides are visible).

The invention is defined in the independent claims. Some optional features are defined in the dependent claims.

A claimed apparatus for constructing a data model of a goods package from a series of images, where one of the series of images comprising an image of the goods package provides a number of technical benefits over existing systems. For instance, a user of the apparatus can determine, for a pallet of goods packages, at least three important things:

1. the number of packages on the pallet
2. whether there is sufficient information capture on each package
3. which goods are in each package on the pallet.

The packages in question can be any type of goods package, including goods cartons made of cardboard (or similar) or plastic, metal containers, wooden boxes/crates, paper/textile bags, packages of or wrapped in plastic film—whether clear (transparent) plastic film, or opaque/partially opaque film—or trays for placing goods in or on, with or without wrapping.

The apparatus does this by recognising data elements (for example, logos, shipping labels having barcodes, shipment numbers, goods serial numbers and other human readable characters, and other shipping marks), associating these with a visible side of the package and, where appropriate, associating multiple visible sides of a particular package. Data elements can also be considered to be data relating to almost any element in or on the package. For instance, data elements which can be recognised include the shape and/or size of a product in or on a package (e.g. size and shape of a soft drink bottle in or on a package), colour of a product (e.g. the colour of the packaging of the product, or logos or other markings thereon, in or on the package), other machine-readable information, such as barcodes printed on the package and/or the package wrapping and/or on goods within the package, and carton/package handles or other parts, or even the element distribution density specific for some goods. Additionally, data elements can be considered to be human-readable characters (e.g. alphanumeric text) on a package and/or an item in/on the package. So the apparatus is able to generate a record for each package which presents a summary of all labels, barcodes, texts, logos, etc. recognised on all visible sides for that package, and/or a record of the shapes and sizes of items in or on a package. Ultimately an operator may be able to derive useful data generated automatically by the apparatus including number of goods packages, each part number in the goods packages, serial numbers for the contents of each goods package and/or part number, a quantity of items in/on the package and so on. The apparatus can also recognise the items in/on the package. The goods package(s) are re-constructed in a data model providing a useful and reliable result for the operator.

When constructing a data model of the goods package(s), the claimed apparatus is able to detect that some packages have, for example, two labels visible. A user can then (if needed) compare results for each label on a particular package. Additionally, the apparatus can count the content for each package and if a label for one or more packages are not visible, it is possible to generate an operator alert and the entry can be corrected manually.

Other benefits achievable with the techniques disclosed herein include:
the apparatus makes use of “normal” barcodes on the goods packages, but it is also possible to utilise all available information on the package itself, including human-readable markings corresponding to the barcodes, text labels, logos etc., and properties of the items in/on the packages themselves, such as size, shape and colour of packaging and markings.
some of the disclosed techniques use pre-set templates, chosen via a neural network being fed with cargo-specific parameters, in order to reduce the possibility of human error and decrease processing time for the goods package(s).
some of the disclosed techniques can retrieve spatial information about the various barcodes and data zones and correlate these to physical locations on a goods package.
with some disclosed techniques, it is possible to cope with missing or damaged labels by using a neural network to compare human readable and machine readable information on a package and/or pallet and make a heuristic determination of the correct data to present to the WMS or ERP systems.
data can be extracted from the reconstructed data model to be provided to backend databases, and uses neural networks to anticipate and correct erroneous pallet/package data and heuristically determine and transmit correct pallet/package data.
For drastic errors, it is possible to cut-out the unreadable/erroneous part of an acquired image of the goods package(s) and to transmit a hi-resolution photograph of the goods package(s) (or parts thereof) to a remote operator who can determine/and or supervise a corrective course of action.

These techniques will be described in greater detail below.

The invention will now be described, by way of example only, and with reference to the accompanying drawings in which:

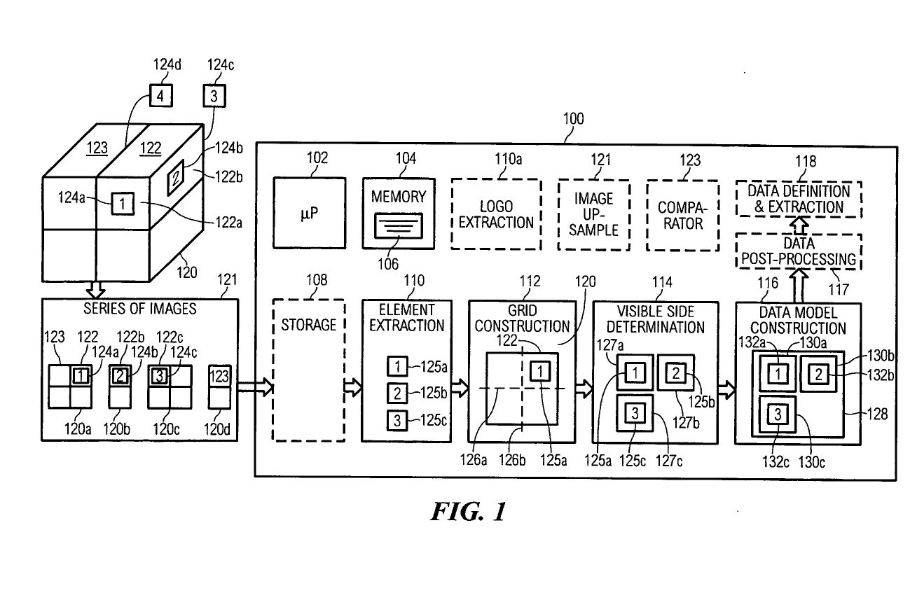

FIG. 1 is a block diagram representing an architecture for a first apparatus for constructing a data model of a goods package from a series of images;

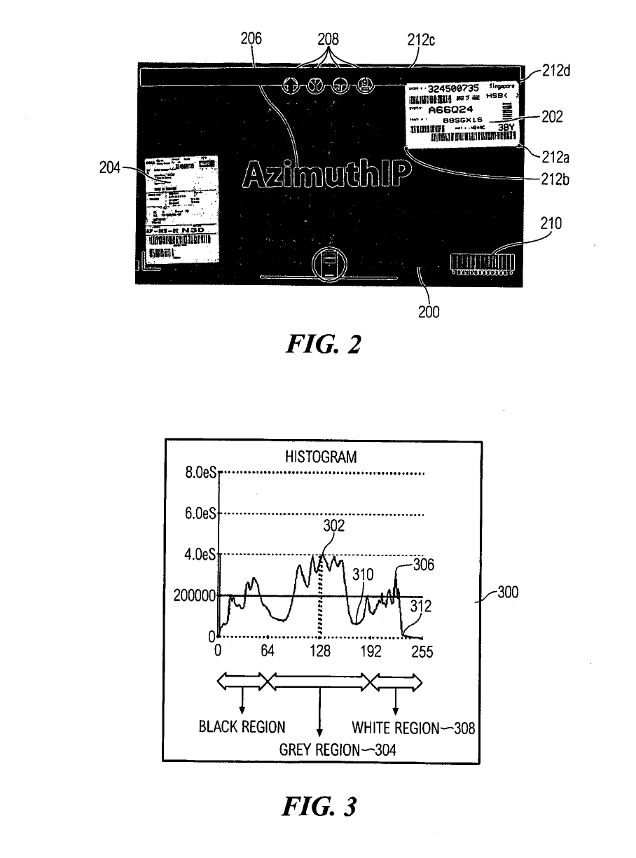

FIG. 2 is an image of a side of a goods package;

FIG. 3 is an intensity histogram of the image of FIG. 2;

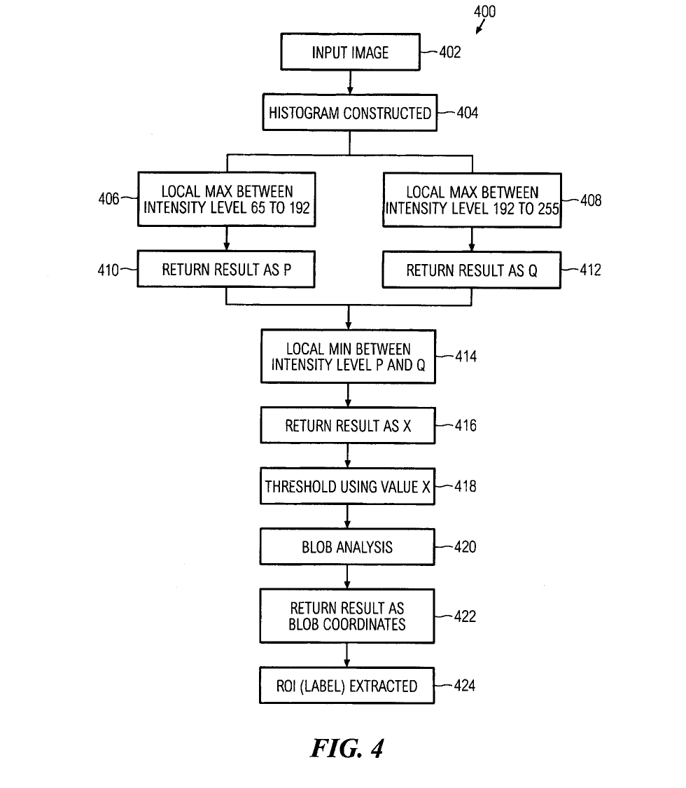

FIG. 4 is a flow diagram illustrating an element (label) extraction process implemented on the apparatus of FIG. 1;

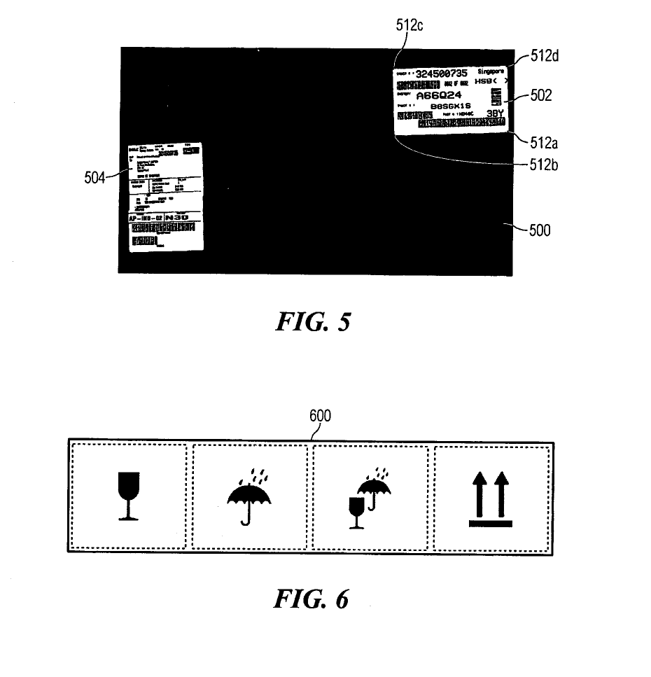

FIG. 5 is a post-processed version of the image of FIG. 2 after processing by the apparatus of FIG. 1;

FIG. 6 illustrates images of typical shipping icons/handling marks;

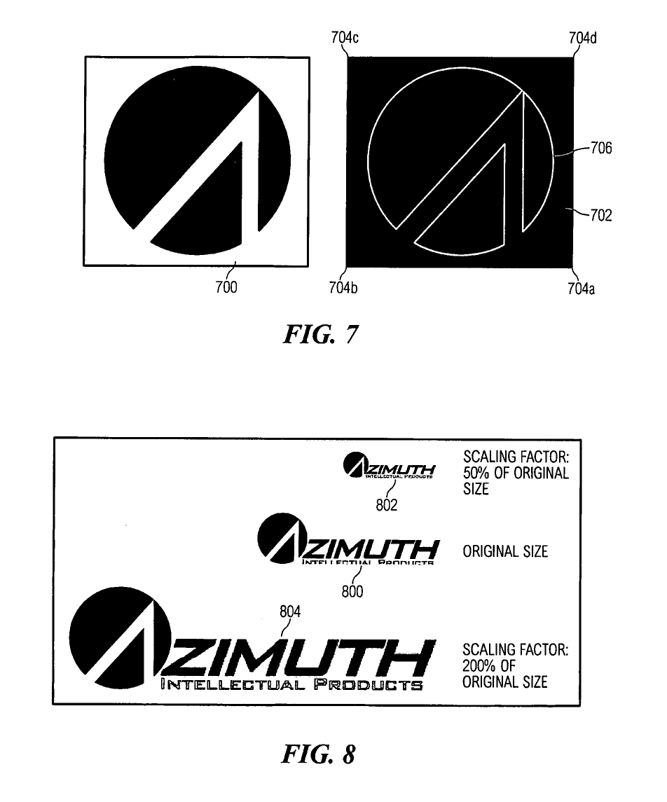

FIG. 7 is an illustration of geometric representation of a logo typically found on a goods package;

FIG. 8 is an illustration representing the processing of an image with a scaling factor applied;

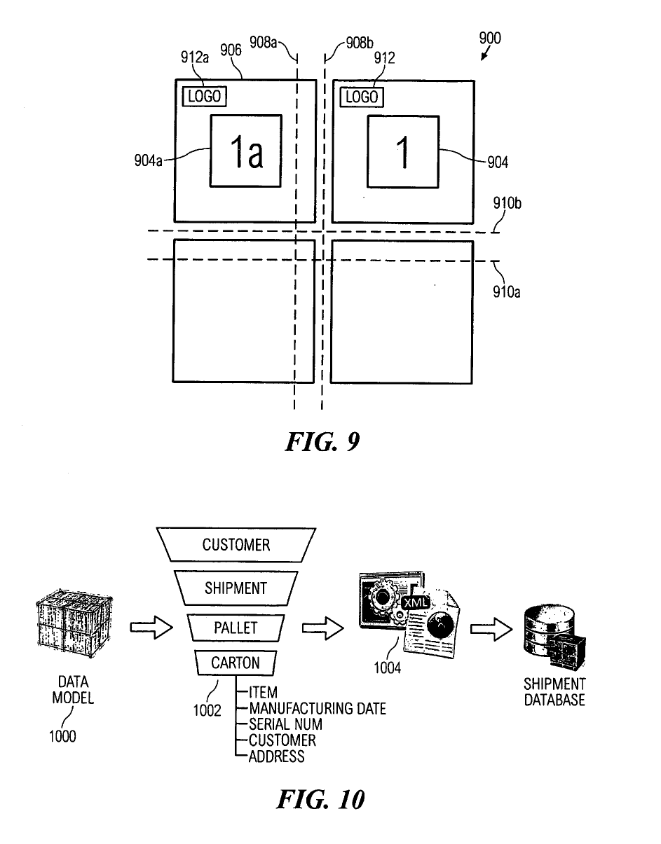

FIG. 9 is a block diagram illustrating the operation of the grid construction module of the apparatus of FIG. 1;

FIG. 10 is a flow diagram illustrating the data definition and extraction module optionally used by the apparatus of FIG. 1;

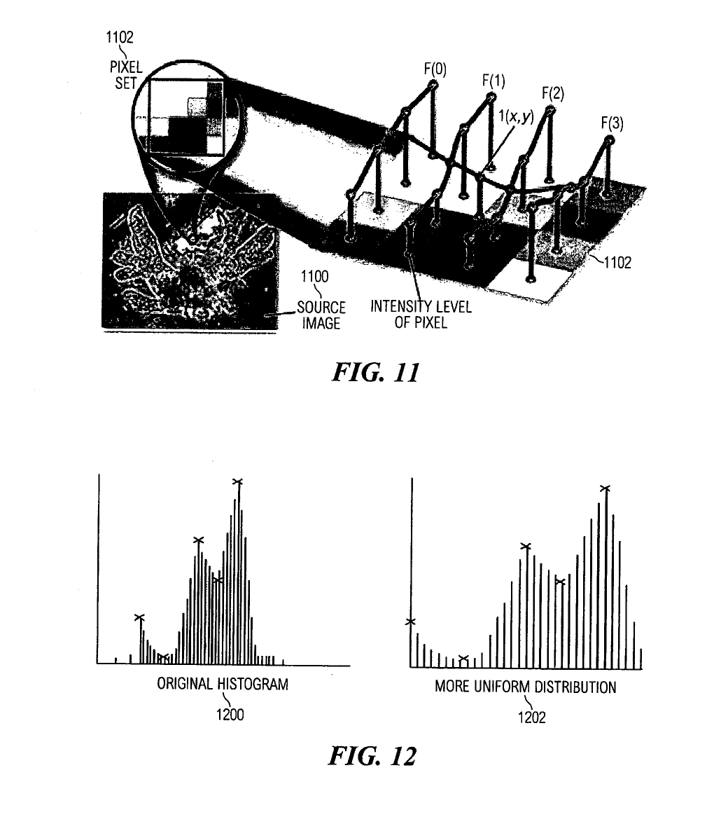

FIG. 11 is an illustration of a bi-cubic sampling algorithm optionally utilised by the apparatus of FIG. 1;

FIG. 12 is a histogram chart illustrating an image histogram before and after application of a bi-cubic sampling algorithm and an auto-levelling operation;

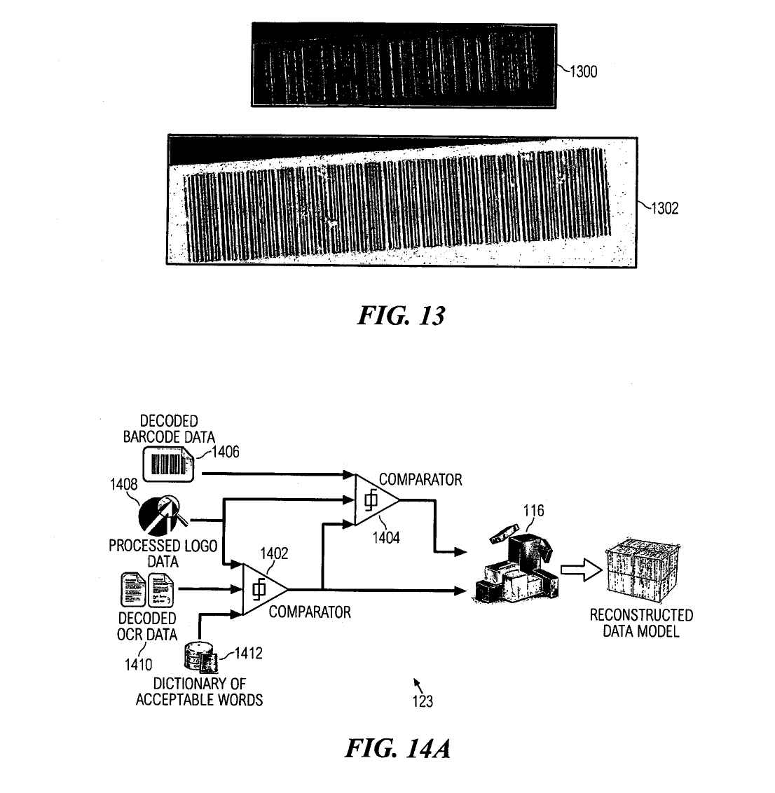

FIG. 13 illustrates an image of a barcode before and after application of a bi-cubic sampling algorithm and an auto-levelling operation;

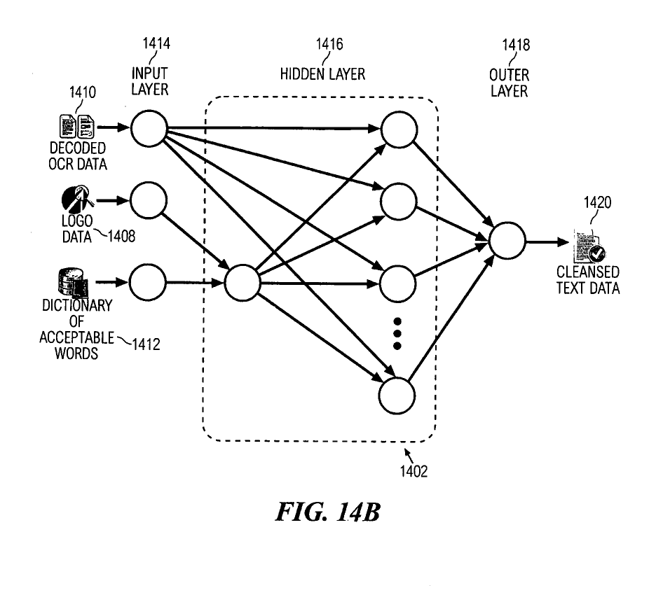

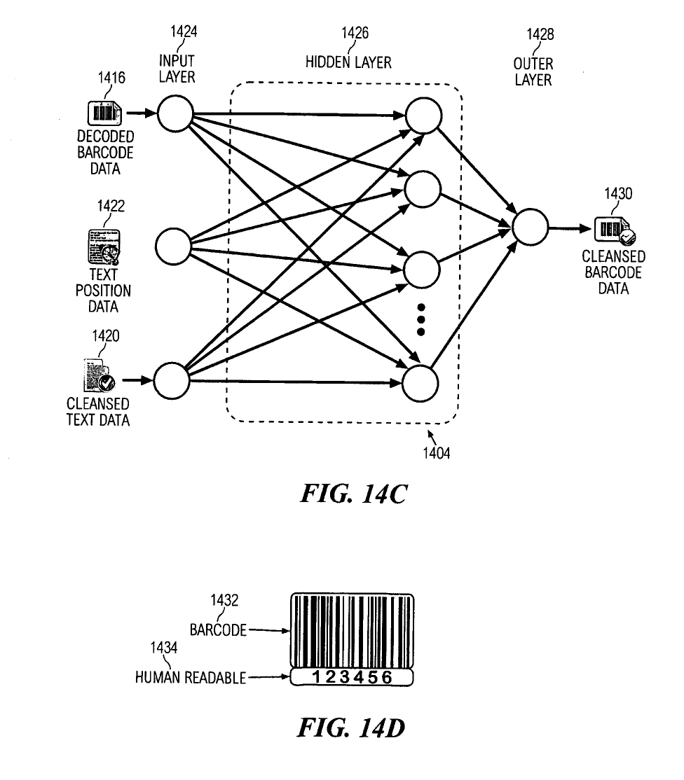

FIG. 14 is a flow diagram illustrating the neural data processing/comparator module optionally used by the apparatus of FIG. 1; and

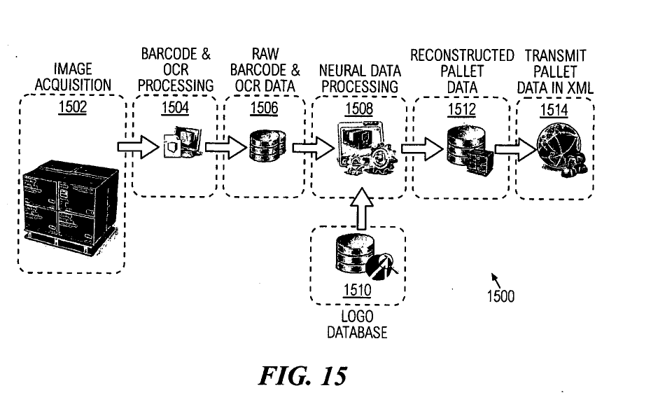

FIG. 15 is a flow diagram providing an alternative view of a process carried out by the apparatus of FIG. 1 when implementing the optional modules of FIGS. 11, 10 and 14.

Turning first to FIG. 1 apparatus 100 comprises a microprocessor 102 and a memory 104 for storing routines 106. The microprocessor 102 operates to execute the routines 106 to control operation of the apparatus 100 as will be described in greater detail below. Apparatus 100 processes a series 121 of images of a goods package 122 which, in the example of FIG. 1, is in a stack 120 of goods packages. Apparatus 100 comprises optional storage memory 108 for receiving and storing the series of images 121. Apparatus 100 is also configured to perform data element extraction with element extraction module 110 and data model construction with data model construction module 116. In the example of FIG. 1, the data model construction module uses grid construction module 112 for constructing data grids and a visible side determination module 114 for determining a number of visible (i.e. not blocked from view of a viewer of the carton stack 120) sides 124a, 124b, 124c of the goods package 122.

Apparatus 100 also optionally comprises a data model post-processing module 117 and a data definition and extraction module 118. Apparatus 100 also optionally comprises logo extraction module 110a. In the example of FIG. 1, logo extraction module 110a is a separable, stand-alone module but may also be part of the element extraction module 110. Apparatus 121 also optionally comprises an image up-sample module 121 to perform an image up-sample algorithm to enlarge and process an image part extracted by element extraction module 110 from one of the series 121 of images and a comparator module 123 which performs, for example, neural analysis—via a neural network—on data extracted by at least element extraction module 110 and, optionally, logo extraction module 110a.

To summarise the operation of apparatus 100, the apparatus 100 constructs a data model of a goods package 122 from a series 121 of images 120a, 120b, 120c, 120d, where (at least) one of the series of images comprises an image of the goods package 122. The apparatus 100 comprises a processor 102 and a memory 104 for storing one or more routines 106 which, when executed under control of the processor 102, cause the apparatus 100 to utilise element extraction module 110 to extract element data 125a, 125b, 125c from goods package elements 124a, 124b, 124c in the series of images 121. Apparatus 100 utilises grid construction module 112 to construct a data grid for each of the series of images 120a, 120b, 120c, 120d from the element data 125a, 125b, 125c which requires the goods package 122 being represented in at least one of the data grids. (For example, goods package 122 is not represented in the data grid constructed for image 120d as it is obscured from view in the image 120d.) Apparatus 100 also employs a visible side determination module 114 to determine, from the data grids, a number of visible sides 127a, 127b, 127c of the goods package 122 and utilises data construction module 116 to associate element data 132a, 132b, 132c from the visible sides 127a, 127b, 127c of the goods package with the goods package (or a representation 128 thereof in the data model construction module 116).

It will be appreciated that the modules 110, 112, 114, 116, 117, 118, 110a, 121 and 123 may be modules implemented in the routines 106 stored in memory 104 and executed under control of the microprocessor 102.

The operation of apparatus 100 will now be described in greater detail. A stack 120 of goods packages is illustrated. Within the stack is goods package 122 having sides 122a, 122b which are visible in the view of FIG. 1. Goods package 122 also has sides 122c and 122d which are not visible in the view of FIG. 1 as side 122c is at the rear of the goods package 122 in the perspective of FIG. 1 and side 124d is at a left side in the perspective of FIG. 1 but would, in any event, be obscured from viewing from the left side by box 123. In the example of FIG. 1, goods package 122 is a generally cuboid goods carton made of, say, cardboard material or similar, but the techniques described are applicable for any type of goods package.

A series 121 of images 120a, 120b, 120c, 120d of the stack 120 of goods packages are acquired. In the example of FIG. 1, the series 121 of images 120a, 120b, 120c, 120d represent, respectively, “front”, “right-side”, “rear” and “left-side” views from the perspective of the view point of FIG. 1. For example, image 120a shows a front view of stack 120 illustrating goods packages 122 and 123 in their respective positions. Also illustrated in the view 120a is a goods package element 124a which may comprise, for example, of a label or logo affixed or printed on to the goods package 122, or other shipping mark such as a handling mark etc. Similarly, image 120b shows the right-side view of the stack 120 of goods packages and includes an image of side 122b of goods package 122 and a second goods package element 124b. Rear view 120c illustrates rear views of goods packages 122 and 123 and, of goods package 122, a rear side 122c is illustrated with a third goods package element 124c. In image 120d, a left side view of the stack 120 of goods packages is visible, showing a left side of goods package 123. A left-side view of face 124d of goods package 122 and fourth goods package element 124d are obscured from view in image 120d because of the relative placement of goods package 123 with respect to goods package 122.

The series 121 of images are received at apparatus 100 by conventional means such as an i/o port/module and, optionally, stored in memory 108. Apparatus 100 is configured under control of the processor 102 to extract element data from the goods package elements in the series 121 of images. So, for example, element extraction module 110 operates to extract data relating to first, second and third goods package elements 124a, 124b, 124c. The elements are extracted as data objects 125a, 125b, 125c and some techniques for this operation are described in greater detail below with respect to FIGS. 2 to 8.

Next, apparatus 100 operates to construct the data model by associating element data from a number of visible sides of the goods package with the goods package constructs. In the example of FIG. 1 this done by, first, constructing a data grid for each of the series 121 of images. The data grid is constructed using at least the element data objects 125a, 125b, 125c as will be discussed in greater detail with respect to FIG. 9. Each data grid models the separation of each of the discrete goods packages with modelled grid lines 126a, 126b. The goods package 122 is represented in at least one of the data grids but, in the example of FIG. 1, it will be represented in each of the data grids constructed for the views 120a, 120b and 120c as the goods package 122 is visible in these images.

Apparatus 100 then determines from the constructed data grids which of the sides 127a, 127b, 127c of the goods package 122 are visible in the series 121 of images 120a, 120b, 120c and 120d. In this process, apparatus 100 determines which of the modelled goods package elements 125a, 125b, 125c are visible (i.e. not obscured by other goods packages) in the image(s) of stack 120.

Apparatus 100 then goes on to construct a data model of the goods package (and, perhaps, any other goods packages in the stack 120) by associating element data 125a, 125b, 125c from the visible sides 127a, 127b, 127c and associates these objects together in the data model objects 132a, 132b, 132c respectively as modelled sides 130a, 130b, 130c of modelled goods package 128.

Optional module 110a is discussed with greater detail with respect to FIGS. 6 to 8. Optional module 117 is discussed in greater detail below. Optional module 118 is discussed in greater detail with respect to FIG. 10. Optional module 121 is described with respect to FIGS. 11 to 13. Optional module 123 is described in greater detail with respect to FIGS. 14 and 15. An overall system incorporating the optional modules is described in greater detail with respect to FIG. 15.

Although in the example of FIG. 1, the apparatus 100 is illustrated as being a single item of apparatus providing all the structure/functionality necessary for implementation of the techniques described herein, it will be appreciated that the functionality/techniques may be implemented in two or more discrete items of apparatus.

Turning now to FIG. 2, operation of element extraction module 110 is discussed in greater detail. The discussion is given in the context of the goods package being a goods carton made of cardboard, plastic or similar material, but the techniques are applicable to all types of goods packages. An acquired image of a side 200 of a goods package is illustrated. Visible in the image are labels 202 and 204, a vendor logo 206, handling/shipping marks 208 and barcode 210. Label 202 has co-ordinates 212a, 212b, 212c, 212d located at the four corners of the label. Information on labels 202, 204 includes human-readable alpha-numeric characters and barcodes. In the example of FIG. 2, the image of side goods package side 200 is an 8-bit per pixel greyscale high resolution image. The techniques disclosed herein are readily extendable to use with colour images, but it has been found that in some implementations better performance is achieved using a greyscale image.

Apparatus 100 seeks to extract a goods package element—in this case element 202 which is a label—from the image by determining the co-ordinates 212a, 212b, 212c, 212d of the label within the image. These co-ordinates are located at the corners of the label (the element) in the example of FIG. 2, but it will be appreciated that other points/co-ordinates of the label within the image could be determined either in addition or as an alternative to these points. When the techniques are applied to a goods package of, say, soft drinks bottles or tins covered in transparent film, the apparatus operates to analyse the bottles, tins or similar, seeking to extract a goods package element such as size or shape of the bottle/tin. Item co-ordinates then relate to the shape of the item, and the outline of the item in the image. Additionally, if colour of the product is to be recognised, the image operated upon can be a colour image.

Apparatus 100 examines the image 200. This may be done by constructing an image histogram 300 for pixels of the image 200 and this is illustrated in FIG. 3. In the example of FIG. 3, the value on the Y-axis is an intensity value and the value of the X-axis is an eight-bit monochromic value varying from 0 (for pure black) to 255 (for pure white). From the histogram 300 it is observed that pixel values are, generally, divided into three major groups: a black region (words and background), a grey region (package) and a white region (label). Similar techniques are also generally application for colour images.

From the histogram (either constructed by or received at the apparatus 100) apparatus 100 determines a first maximum intensity value 302 in the first intensity region (in the example of FIG. 3, the grey region) 304 and a second maximum intensity value 306 in a second intensity region (in the example of FIG. 3, the white region) 308. Apparatus 100 then searches for a minimum intensity value 310 between the first and second maximum intensity values 302, 306. The reason for this is that, typically, the intensity values for the white region exhibit—or at least resemble—a Gaussian distribution. In the example of FIG. 3, it can be seen that the histogram curve for the white region 308 resembles a Gaussian distribution (or at least exhibits Gaussian-like properties) with a minimum value at 310 where grey blends into white, a maximum value at 306 and a second minimum value at 312 at pure white. Apparatus 100 identifies those pixels which satisfy a threshold criterion determined with respect to the minimum intensity value. In this example, apparatus 100 conducts a threshold operation which uses local minimum 310 as a threshold point, effectively separating the label/sticker out from the package background.

Co-ordinates of the label 202 (co-ordinates, 212a, 212b, 212c, 212d in the example of FIG. 2) are determined from the thresholding operation. It is also possible to apply a blob analysis (as is known to the skilled person) to the ‘threshold-ed’ image, to compute the coordinates of the labels.

The remainder of the image 200 is then masked as illustrated in FIG. 5, which shows the labels 202, 204 processed as labels 502, 504 in the processed image, with label 502 having detected co-ordinates 512a, 512b, 512c, 512d. Apparatus 100 then extracts the ‘white’ region (labels 502, 504), which reduces the processing burden required of the remaining modules of the apparatus 100.

The process flow 400 is illustrated with respect to FIG. 4 and an image 200 is input at step 402. Apparatus 100 constructs the histogram 300 at step 404 before searching for the first maximum intensity level 302 in the grey region with a monochromic value between 65 and 192 at step 406. In step 408, apparatus 100 searches for the second maximum intensity level 306 in the white region with a monochromic value between 192 and 255. The maxima 302 and 306 are returned at steps 410, 412 as respective values P and Q before the local minimum 310 between P and Q is searched for by apparatus 100, where the value is returned as value X. Apparatus 100 then applies the thresholding operation using value X at step 418 before, in this example, performing blob analysis at step 420. The blob co-ordinates are returned at step 422 as the label results defining the Region of Interest (ROI), before apparatus 100 extracts the label at step 424.

Part of the element data extraction process may include apparatus 100 performing OCR techniques to extract the human-readable alpha-numeric characters on the label and conventional techniques to read the label barcodes for use in the data modelling.

The goods package element extraction module may be provided separately in which an apparatus is provided, the apparatus having a processor and a memory for storing one or more routines which, when executed under control of the processor, control the apparatus to extract element data from goods package elements in the series of images, where one (or more) of the series of images comprises an image of the goods package. The techniques which may be applied for this apparatus/method are as described above in the context of FIGS. 1 to 5.

Additionally, or alternatively, element extraction is performed by apparatus 100 to perform logo recognition (module 110a) on the series 121 of images received at the apparatus. In one implementation, apparatus 100 operates on a smaller version of the images by down-scaling the (relatively) high-resolution images 120a, 120b, 120c, 120d to a smaller scale. In one implementation each of the series 121 of images comprises of an 80 MegaPixel image and the image is reduced by 2500% to provide an image of approximately 3.2 MegaPixels. This step is to provide a smaller and workable input image as the logo recognition algorithm works significantly faster with smaller images.

Apparatus 100 then operates to compare shapes detected in the image against a database (not illustrated) of known customer images and icons. The “customers” in this respect may include those entities whose goods are contained within the goods packages, goods recipients, and the like. Typical images the apparatus 100 operates on include the shipping icons 600 of FIG. 6 and/or known shapes, sizes and/or colours of products in/on a goods package.

The logo recognition algorithm operates under control of processor 102 to find models using edge-based shape detection to find edge-based geometric features, hence the logo recognition algorithm has greater tolerance of lighting variations, model occlusion, and variations in scale and angle as compare to the typically used pixel-to-pixel correlation method.

Thus, apparatus 100 can be operated on a typical logo such as logo 700 of FIG. 7 to determine a geometric representation 702 of the logo and to determine a property of the logo such as the shape of circular edge 706 or one (or more) of the co-ordinates 704a, 704b, 704c of the logo (or the geometric representation 702 of the logo). Again, similar techniques can be applied to shape recognition for elements of an item in/on a goods package. Indeed, the item in/on the goods package may be considered an element itself.

The apparatus 100 operates the logo recognition algorithm to recognise logos of various sizes using a scaling factor feature. The default range of the Scaling Factor is variable between 50% to 200% of library's logo size. By implementing this, it is possible to filter out very small images, such as one might find on packing tape on the goods package.

The algorithm output is one or more logo parameters, including one or more of logo type, logo model, logo image co-ordinates, logo angle of orientation, and logo match likelihood score (i.e. the likelihood the logo has been correctly recognised). A logo may not be fully recognised for a number of reasons. For instance, a logo could be partially obscured by, say, a packing strap, or it could be damaged. If apparatus 100 does not find an exact match, it can apply heuristic analysis to determine a likelihood the logo has been correctly recognised. The apparatus can output these parameters in a data set format, for example in the format of [Logo no.], [Logo Model], [X1], [Y1], [X2], [Y2], [Angle], [Score], where [Logo no.] is a count allocated to the logo, [Logo Model] defines the type of logo which may define, for example, a particular company which uses the logo, [X1], [Y1], [X2], [Y2] are the logo co-ordinates (in pixels) in the image, [Angle] is the angle of orientation of the logo (for example, if the logo was placed on the goods package 122 in an incorrect orientation, and [Score] is a likelihood score of a correct detection.

After label extraction, apparatus 100 operates to construct a data model of one or more goods packages 122 in the stack 120 of goods packages. In the example of FIG. 1, apparatus 100 performs this by constructing the data model by associating element data from a number of visible sides of the goods package with the goods package. Thus, apparatus 100 does this starting from the element data previously extracted which may include label information, label co-ordinates, logo information and co-ordinates, item shape, size, colour etc. Apparatus 100 performs data modelling to (re-)model a goods package based on data extracted for the goods package. This includes an analysis of the relative position of elements which can be based on the X- and Y-coordinates of significant goods package elements such as labels, logos, handling marks, items in/on the package etc.

Based on these significant goods package elements, apparatus 100 optionally constructs a preliminary grid of goods packages from element positional data, the preliminary grid of goods packages comprising a grid of the goods package being remodelled and a second (adjacent) goods package. Apparatus 100 makes this preliminary grid of packages based on the assumption that one package ends somewhere before an adjacent one starts. Referring to FIG. 9, a depiction of a data model 900 of a stack of goods packages including packages 902 and 906 is given. Goods package data object 902 comprises data objects for package elements 904 (e.g. a label) and 912 (a logo). Additionally, text (having human-readable characters and/or numbers), such as product name, part name, expiry date, etc.) extracted from the image may also be considered package elements. A corresponding data object for package 906 comprises data objects for package element 904a (another label which, in the example of FIG. 9, corresponds—e.g. is similar or identical—to label 904 of goods package 902) and 912a (another label which, in the example of FIG. 9, corresponds to logo 92 of goods package 902). Apparatus 100 has at least some basic knowledge of the element parameters, such as size and position (co-ordinates) in the image/data model and can construct the preliminary grid of goods packages by defining a grid line between an element of the goods package and a corresponding element of the second goods package. Apparatus 100 defines preliminary grid line 908a as an approximation of a boundary line between packages 902 and 906 from knowledge of elements 904, 904a. A similar line 910a is generated for the packages immediately below packages 902, 906.

An additional method of preliminary grid construction may be based on knowledge of shapes of a certain size; for example, if apparatus 100 has found a rectangular shape not less than, say, the approximate shape of a goods package, such as 30 cm long by 40 cm high which contains only one significant goods package data element like a label or a logo, the rectangle can be treated as a “guessed” single package.

The apparatus 100 goes on to construct a preliminary grid matrix having a matrix value defining a goods package element type and a goods package element position and correlating the preliminary grid matrix with a template matrix for a match and, in dependence of a match, refining the preliminary grid to define the data grid. Each significant element will most likely be positioned on a goods package according to a known format for a particular product or manufacturer. For instance, all goods packages containing a particular model of DVD players from a particular manufacturer will have their labels and logos etc. at approximately the same place. Apparatus 100 can be trained with knowledge of these templates, defining a set of options. For example, a logo (denoted “element A”) may be located at one position (or more) on a goods package side at, say, top right, top middle, top left, bottom right, bottom middle or bottom left. Each of these positions are allocated a position value—options 1, 2, 3, 4, 5, 6 respectively. A label (e.g. denoted “element B”) can be defined in the same way as can any other goods package element. So as the outcome apparatus 100 constructs a preliminary grid matrix having at least one value defining the element type and the element position, but more likely the preliminary grid matrix has multiple values in the form [A1, B3, C5, D2 . . . Xn) where an alphabetic character A, B, C, D, . . . X defines an element type and a numeric character 1, 3, 5, 2, . . . , n defines a position for the element on the goods package. This preliminary grid matrix is correlated with at least one template matrix which is defined for a particular product from a particular manufacturer and may be stored in storage memory 108. Of course, it is possible to correlate the preliminary grid matrix with multiple template matrices for multiple products from multiple manufacturers. If the preliminary grid matrix matches with a template matrix (for example—LCD TVs from Manufacturer Y) the apparatus then can derive knowledge of the shape of the goods packages working from the element positions as a reference. Apparatus 100 then is able to refine the preliminary grid to a confirmed grid and shifts grid lines 908a, 910a to lines 908b, 910b to define the data grid. Significant elements, including recognised labels, logos and barcodes, and (if any) damage within each goods package boundaries defined by the lines of the data grid (in pixels) are associated with the a particular goods package. For instance, in the data model depicted by 900, label 904 and logo 912 are associated with goods package 902.

As an outcome, apparatus 100 has a grid with at least one goods package which can be defined in terms of rows and columns. This data grid defines a data model of one side of the stack 120 of packages illustrated in FIG. 1. Apparatus 100 derives knowledge of how many packages are shown on each photo (for example, by counting the occurrences of a logo or a label or other goods package element), and all data relating to each package shown on that photo.

The process is repeated for multiple sides of the stack 120 of packages. In the present example, four data grids are constructed, one for each of the views 120a, 120b, 120c, 120d of FIG. 1. From this, goods package reconstruction can begin.

For each row in the data grid on all four goods package sides, apparatus 100 applies the following rules:

Rule 0: If each QTY_PER_SIDE=1, then this package has 4 sides visible (1 package in the stack 120)

### IF RULE 0=FALSE:

Rule 1: If (QTY_PER_SIDE)=1 for any side means only one package is visible in the stack on that side and the stack is only one-deep on that side), then this package has 3 sides visible
Rule 2: if (QTY_PER_SIDE)=2 (means we have 2 packages on that side), then each package on this side has minimum 2 sides, maximum 3 sides visible
Rule 2_{—}1: For each side A, If RULE2=TRUE and (Package_Position) is Most_Left (means package is on the left edge of the side), and (Side D QTY_PER_SIDE)=1, then such package has 3 sides, if (Side D QTY_PER_SIDE)>1, then such package has 2 sides visible
Rule 2_{—}2: For each side A, If RULE2=TRUE and (Package_Position) is Most_Right (means package is on the right edge of the side), and (Side B QTY_PER_SIDE)=1, then such package has 3 sides, if (Side B QTY_PER_SIDE)>1, then such package has 2 sides visible
Rule 3: if (QTY_PER_SIDE)>2, (means we have 3 or more packages on the side), then each package on this side has minimum 1 side, maximum 3 sides visible
Rule 3_{—}1: For each side A, If RULE3=TRUE and (Package_Position) is Most_Left (means package is on the left edge of the side), and (Side D QTY_PER_SIDE)=1, then such package has 3 sides, if (Side D QTY_PER_SIDE)>1, then such package has 2 sides visible
Rule 3_{—}2: For each side A, If RULE3=TRUE and (Package_Position) is Most_Right (means package is on the right edge of the side), and (Side B QTY_PER_SIDE)=1, then such package has 3 sides, if (Side B QTY_PER_SIDE)>1, then such package has 2 sides visible
Rule 3_{—}3: For each Side A, if (Package_Position=Most_Left)=False and (Package_Position=Most_Right)=False, and ((Side D QTY_PER_SIDE)=1 and (Side B QTY_PER_SIDE)=1), and on side C there is a package with mirror position and size, then ASSUME that such package has 2 sides visible otherwise such package has 1 side visible

Based on the results from the application of Rules 0 to 3, the apparatus 100 is able to determine a number of visible sides for a particular goods package 122 and, from positional data, is able to determine which adjacent faces belong to the same goods package. Apparatus 100 then constructs the data model by joining adjacent package faces (e.g. faces 122a, 122b and 122c of package 122 of FIG. 1) for the sides of the stack 120 of pallets. Element data from the number of visible sides of the goods package are then associated with the goods package in the data model. For instance, apparatus 100 constructs a data model of goods package 122 which knows that goods package faces 122a, 122b, 122c are faces of goods package 122 and that goods package elements (e.g. labels 124a, 124b, 124c) and all readable data thereon are associated with goods package 122. So apparatus 100 associates data relating to a goods package in the image with the goods package; that is, apparatus 100 defines a data model in which one or more goods package 122 is defined by a summary of all labels, barcodes, texts and logo recognised on all visible sides for that package.

Each package's data after that may be compared by a comparator in for, example, data post-processing module 117 which implements comparator functionality similar to that described with reference to FIG. 14 below, but in accordance with rules set by templates for logo type and position (say, one rule for TV, another for fridges etc.). If all data correlates, and sufficient information (i.e. Part Number, Serial Number etc.) is available for each package, a result for each package is sent to the database by data definition/extraction module 118. If not, an alarm will be sent to the remote operator/local operator, detailing the package position on pallet mentioned, to overturn or to make a manual entry into system

The same process is repeated for all rows of the pallet.

As the outcome, the apparatus defines a data set for a goods package from the element data for the number of visible sides detected. This can, optionally, be output as a data set by data definition and extraction module 118 of FIG. 1. The data set is defined for each goods package as Package=[Side1 (logos; text; barcodes) . . . Side4 (logos; text; barcodes)] with respective coordinates (x,y) on each side. If less than four sides are visible—e.g. in the example of FIG. 1, side 124d of package 122 is obscured by package 123 (see the view 120d), the values for Side 4 are null.

The goods package construction modules/functionality may be provided separately, in which case an apparatus has a processor and a memory for storing one or more routines which, when executed under control of the processor, control the apparatus to construct a data grid for each of series of images from element data extracted from the series of images, where the goods package is represented in at least one of the data grids. The techniques used are as described above in the context of FIG. 1. The separate apparatus/method determines, from the data grids, a number of visible sides of the goods package and constructs the data model by associating element data from the number of visible sides of the goods package with the goods package.

Although FIG. 9 is discussed in the context of a generally cuboid goods carton, the techniques are also applicable with any type of goods package, and may also be utilised when recognising the shape, size and/or colour of an item in/on the package.

Ultimately apparatus 100 is able to extract a great deal of information from the images of the goods package/stack of packages, in an automated and highly-reliable fashion. This data can include the number of packages in the stack, number of items in the packages, part numbers of the items in the packages, serial numbers and so on. The stack of goods packages has been pallet (re-)constructed from the series of images thus providing a result which is commercially viable for the customer, and reliable.

The data extraction is depicted in FIG. 10. The data model 1000 which in this example is a model of a 2×2×2 stack of goods packages is defined by a data set 1002 which can define various shipping information including customer name/reference, shipment number, pallet number, package number/contents, etc. The data model can then be converted to XML format and transmitted to a back-end shipment database for data manipulation, checking etc.

Referring back to FIG. 1, the optional image up-sample algorithm will now be described with respect to FIGS. 11 to 13. The purpose of this algorithm is to up-sample an image (such as a barcode image) extracted from a label to, say, 200% of its original size. Barcode Reading algorithms are based on the gradient of lines. The Applicant(s) have determined that an up-sampled interpolated image yields far greater accuracy than the original resolution image. The up-sampled interpolated image provides more pronounced gradients facilitating the barcode detection process. Thus, the apparatus 100 system uses bi-cubic sampling to up-sample the images then applies an ‘auto levelling’ technique.

Referring to FIG. 11, bi-cubic interpolation is applied by fitting a series of cubic polynomials to the brightness values contained in a 4×4 array 1102 of pixels in source image 1100 surrounding a calculated address. A cubic polynomial, F(i) (where i=0 . . . 3), is fitted to the control points in the y-direction. Next, apparatus 100 uses a fractional part of the calculated pixel's address in the y-direction to fit another cubic polynomial in the x-direction, based on the interpolated brightness values that lie on the curves. The apparatus 100 then substitutes the fractional part of the calculated pixel's address in the x-direction into the resulting cubic polynomial to yield the interpolated pixel's brightness value.

Apparatus 100 the uses an auto-levelling operation to adjust automatically the black point and white point in the image. This clips a portion of the shadows and highlights in the greyscale channel and maps the lightest and darkest pixels into each colour channel to a pure white (level 255) and a pure black (level 0). Apparatus 100 then redistributes the intermediate pixel values proportionately. Auto-levelling increases the contrast in an image because the pixel values are expanded thus enhancing system accuracy. This can be seen in FIG. 9, where the original histogram 1200 can be compared with the histogram 1202 after bi-cubic sampling and auto-levelling, where the histogram 1202 exhibits a more uniform distribution.

Apparatus 100 outputs from this stage of this stage will be an image 200% of its original side with auto-levelling. Compare the difference between the original barcode image 1300 and the up-sampled and auto-levelled image 1302 in FIG. 13.

The optional comparator module 123 of FIG. 1 will now be described in greater detail with reference to FIG. 14. When implementing this module, apparatus 100 analyses a candidate character string read in an OCR process from one of the series of images of the goods package. Apparatus 100 determines a first distance between the candidate character string and a first dictionary character string from a comparison of a set of candidate character values for the candidate character string and a first set of character values for the first dictionary character string; and determines, from the comparison, whether the first distance satisfies a comparison criterion.

Referring first to FIG. 14a, comparator module 123 comprises first and second comparators 1402, 1404 for “cleaning” decoded barcode data 1406, processed logo data 1408 derived by module 110a, and decoded OCR data extracted from an image of the goods package. Comparator 1402 performs its analysis with reference to a dictionary of acceptable words 1412 which, in this example, is stored in memory 108 of FIG. 1. The “cleaned” data is passed to the data model construction module 116 for reconstruction of the goods package/stack of goods package to provide a reconstructed data model.

Referring to the example of FIG. 14b, comparator 1402 is implemented as a neural network having input layer neurons 1414, hidden layer neurons 1416 and output layer neurons 1418 thereby to provide “cleaned” text data 1420 for use in the data model construction module and also by comparator 1404 which will be described in greater detail with reference to FIG. 14c.

The data input to the Input Layer 1414 consists of ‘Decoded OCR Data’ 1410, ‘Logo Data’ 1408, and the ‘Dictionary of Acceptable Words’ “DAW” 1412. One piece of decoded OCR data 1410 is a candidate character string for analysis by the apparatus 100, read in an OCR process from an image of a goods package. The Decoded OCR Data (each candidate character string) is, in the example of FIG. 14b, represented by up to 20 neurons. The number of neurons could be more or less and is not critical to the design. Apparatus which implement 20 neurons are able to represent words up to 20 characters. More than 98% of English-language words consists of 20 characters or less.

We refer to all possible characters that can be decoded from OCR as set A:

A={0, 1, 2, 3, 4, 5, 6, 7, 8, 9, A, a, B, b, C, c, D, d . . . Z, z}.

|A|:=cardinality of set A. Or more simply, number of elements in A.

|A|=62, in the example of FIG. 14 (26 uppercase and 26 lowercase alphabetic characters and 10 numeric characters.

In order for the network to work with the words and strings, Apparatus 100 converts every letter in the alphabet to a number and map it to a (normalised) value between −1 and +1 (the activation and de-activation of the neurons), but it will be appreciated that other values, including other normalised values, may also be used.

The distance between adjacent elements aₙ and aₙ₊₁ is 2/62≅(0.0322)

This yields the following mapping:

### {‘0’→(−1.000), ‘1’→(−0.9678) . . . Z→(0.9678), ‘z’→(+1.000)}

Thus, apparatus 100 defines a (first) set of character values for the candidate character string. Apparatus 100 is able to capture any word or string up to 20 characters into the neural network.

DAW 1412 is a database of all the possible words that can appear on a package. In the example of FIG. 14, DAW 1412 is also represented by up to 20 neurons for the same reason as the ‘Decoded OCR Data.’ If one considers a word (or character string in the DAW 1412 as a (first) dictionary character string, this character string may be mapped in a similar way as for the decoded OCR data/candidate character string, thereby to derive a (first) set of character values for the (first) dictionary character string.

Apparatus 100 analyses the candidate character string with reference to the DAW 1412 by determining a first distance between the character and a first dictionary character string from a comparison of the set of candidate character values and the first set of character values for the first dictionary character string. From the comparison, apparatus 100 determines whether the first distance satisfies a comparison criterion. One example of the comparison criterion which may or may not be satisfied is if the distance between the candidate character string and the first dictionary character string is less than a predetermined threshold distance. If less than a predetermined minimum distance, apparatus 100 knows with a reasonable confidence that the candidate character string matches the first dictionary character string (e.g. they are the same or at least similar strings). Thus, the candidate character string is a “valid” character string.

Hidden Layer 1416 uses the ‘Levenshtein Distance’ (LDx) to compare the Decoded OCR Data/candidate character string 1410 with the dictionary character string from the specific database of words in the DAW 1412 and calculates a distance “score” indicating the highest probability match. An exact match would yield a ‘distance’ of zero and give 100% confidence.

In information theory and computer science, the LDx is a metric for measuring the amount of difference between two sequences (i.e., the so called edit distance). The LDx between two strings is given by the minimum number of operations needed to transform one string into the other, where an operation is an insertion, deletion, or substitution of a single character.

A bottom-up dynamic programming algorithm for computing the LDx, familiar to persons skilled in the art, involves the use of an (n+1)×(m+1) matrix, where n and m are the lengths of the two strings. This algorithm is based on the Wagner-Fischer algorithm for edit distance. The following is pseudocode for a function LevenshteinDistance that takes two strings, s of length m, and t of length n, and computes the LDx between them:

int LevenshteinDistance(char s[1..m], char t[1..n])

// d is a table with m+1 rows and n+1 columns
declare int d[0..m, 0..n]
for i from 0 to m
d[i, 0] := i
for j from 0 to n
d[0, j] := j
for i from 1 to m
for j from 1 to n
{
if s[i] = t[j] then cost := 0
else cost := 1
d[i, j] := minimum(
d[i−1, j] + 1, // deletion
d[i, j−1] + 1, // insertion
d[i−1, j−1] + cost // substitution
)
}
return d[m, n]

Two examples of the resulting matrix (the minimum steps to be taken are highlighted):

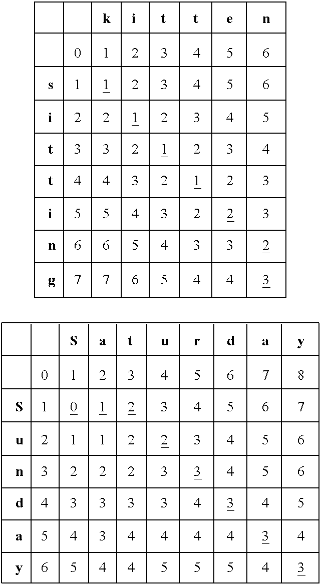

Another example of the comparison criterion which may be satisfied is when apparatus 100 checks the candidate character string against multiple words (character strings) from the DAW 1412. In doing so, apparatus 100 also determines a second distance between the candidate character string and a second dictionary character string from a comparison of the set of candidate character values for the candidate character string and a second set of character values for the second dictionary character string. Apparatus 100 determines, from the first and second distances, a likelihood the candidate character string corresponds to one of the first and second dictionary character strings. Therefore, apparatus 100 chooses the dictionary word with the smallest LDx and subsequent highest confidence and passes that to the Output Layer 1418 as ‘Cleansed Text’ 1420. Of course, multiple checks against higher numbers of dictionary character strings may also be implemented.

Apparatus 100 is able to flag, for a user attention, a candidate character sting which does not satisfy the comparison criterion. Thus, if the LDx is greater than a predefined threshold, apparatus 100 determines that the decoded word is not in the DAW and flags it as a ‘Special String’. This special string could, for example, be a serial number or part number and could be useful in resolving damaged barcodes.

Again, for the same reasons as for the ‘Decoded OCR Data’ 1410, the Output Layer 1418 is represented by 20 neurons and the DAW 1412 is also represented by 20 neurons.

Different vendors have different sets of words. As a result, ‘Logo Data’ 1408 is fed into the DAW neurons to act as a weighting function. This in effect filters out words that the particular vendor, identified by the logo, does not use. To implement this, apparatus 100 selects a dictionary character string from the DAW 1412 for a distance determination dependent upon a likelihood the dictionary character string is relevant to the candidate character string. So, character strings for a particular supplier/customer are not included in the distance calculation.

The comparator of FIG. 14b may be provided in a separate apparatus (not illustrated), in which case an apparatus for analysing a candidate character string read in an OCR process from an image of a goods package comprises a processor and a memory for storing one or more routines. These routines, when executed under control of the processor, control the apparatus: to determine a first distance between the candidate character string and a first dictionary character string from a comparison of a set of candidate character values for the candidate character string and a first set of character values for the first dictionary character string; and to determine, from the comparison, whether the first distance satisfies a comparison criterion.

Apparatus 100 may also be configured to analyse a barcode read from the image of the goods package by determining a barcode distance between the barcode and a barcode-related character string from a comparison of a third set of character values for the barcode and a fourth set of character values for the barcode-related character string and by determining, from the comparison, whether the barcode distance satisfies a barcode comparison criterion. Thus, apparatus 100 also implements the LDx method to find the “barcode distance” thereby to analyse/validate barcodes found in an image. A comparator for providing this functionality is illustrated in FIG. 14c.

Comparator 1404 has data fed to the Input Layer 1424 which consists of ‘Decoded Barcode Data’ 1416, ‘Text Position Data’ 1422, and the ‘Cleansed Text Data’ 1420 derived from the comparator 1402.

Referring to FIG. 14d, barcodes 1432 often have a ‘human readable’ component 1434 within close proximity (‘Barcode Related Text’). The Decoded Barcode 1416 contains the string data extracted from a barcode decoding module (not illustrated, but it implements functionality familiar to the skilled person) as well as positional information (also derivable by conventional means) as to where the barcode physically resides on the package. A set of character values for the barcode (1432 in FIG. 14d) are mapped in a similar fashion as described above in relation to FIG. 14b. A set of character values for the barcode-related character string (human-readable barcode related text—1434 in FIG. 14d) are derived in the same way and a barcode distance between the barcode and the barcode-related text is determined based upon the character values for the barcode and those for the barcode-related character string. Apparatus 100 determines within, hidden layer 1426, if the comparison yields the barcode distance satisfies a barcode comparison criterion (e.g. the detected barcode and the detected barcode text are sufficiently close to one another). If so, apparatus 100 flags the detected barcode as a valid barcode (i.e. it has been read properly).

Apparatus 100 selects a character string in the image of the goods package as a barcode-related character string dependent upon a location of the character string in the image. That is, apparatus 100 uses the ‘Text Position Data’ 1422 to filter out words from the ‘Cleansed Text Data’ 1420 that are more than a pre-defined distance (measured in millimetres) away from a decoded barcode. This results in ‘Barcode Related Text’ being derived by apparatus 100.

This step is implemented if a valid barcode checksum is not detected by apparatus 100. If the Barcode checksum is valid, apparatus 100 has 100% confidence that the barcode has been read correctly, and the original decoded barcode data is passed to the Output Layer 1428. If the checksum is not present or invalid, apparatus 100 implements the LDx method to produce ‘Cleansed Barcode Data’ 1430 from Output Layer 1428.

In one implementation of this, a human-readable character string for the barcode captured in an OCR process is compared with a corresponding barcode. In practice, a common situation is a barcode does 1432 not have a corresponding or associated human-readable character string 1434, containing the (say) serial number“**********’; and the OCR string, containing something like “S/N:***********”. In fact, the two strings may be not even on the same label. However, apparatus 100 has one or more templates describing both possible strings and how to evaluate them, and the apparatus 100 will still, therefore, be able to compare the barcode and the character string when they belong to the same goods package. So, therefore, apparatus 100 is able to determine a barcode distance between a barcode and a barcode-related character string, where the barcode-related character string comprises a character string found on the package in a position not adjacent the barcode. In which case, apparatus 100 is operable to check for a barcode distance between the barcode 1432 and each one of all the character strings found in the image, where the character strings are “barcode-related character strings”.

Apparatus 100 may be further operable to filter character strings for this determination. For instance, if from DAW 1412 apparatus 100 knows that serial numbers for certain vendor should all comprise of seven digits and must start with, say, digit ‘6’ or ‘7’. apparatus 100 can filter these from the distance checking to reduce the processing burden on apparatus 100. Erroneous entries can be removed. It is also possible for apparatus 100 to initiate an alarm if no positive outcome is found.

Additionally or alternatively, if a barcode 1432 has no human-readable part 1434, apparatus 100 is configured to validate the barcode in another way. For instance, if the barcode equates to a part number “12345-67”, and on the same or on another label an EAN code (in a form of barcode, either with or without human-readable part) is found saying something like “4891486936619’, apparatus 100 makes reference to a dictionary of possible part numbers (not illustrated), and, from a check of an equation “4891486936619=Part Number 12345-67”, and the barcode 1432 is therefore validated. Apparatus 100 may also be configured and to correct an incorrectly-detected label containing “12345-67” if it is damaged or partially- or even totally-unreadable.

The comparator of FIG. 14c may be provided in a separate apparatus (not illustrated), in which case an apparatus for analysing a barcode read from an image of a goods package comprises a processor and a memory for storing one or more routines. When executed under control of the processor, the routines control the apparatus: to determine a barcode distance between the barcode and a barcode-related character string from a comparison of a set of character values for the barcode and a set of character values for the barcode-related character string; and to determine, from the comparison, whether the barcode distance satisfies a barcode comparison criterion.

An alternative/additional method of heuristically checking the OCR text is now described. For instance, the system tries to read “Consignee: Azimuth” from a label on a goods package, but the last letter is scratched and cannot be recognized. Apparatus 100 recognises only “Azimut”.

The consignee label image is stored until the full data from the shipment (including other packages/pallets) is checked. Data from “consignee” part of other labels is counted by symbols, and for every symbol, the percentage of presence is calculated (i.e. which percentage of “consignee” part has that symbol, in alphabetic order).

After that apparatus 100 calculates a checksum (A=1, B=2 etc).

In another example, apparatus 100 checks shipment number 123. After a referral to a shipping database, apparatus 100 determines the shipment is a shipment of, DELL™ products on the package it should be written “Consignee: Azimuth”. Apparatus 100 has only recognized “Consignee: Azimut” form the OCR process which does not match the expectation and would, otherwise, cause an error.

Apparatus 100 first calculates a checksum for each character of the text string: C=3, o=15, n=14, s=19, i=9, g=7, n=14, e=5, e=5 etc. (based on alphabetic order), multiplied by a certain coefficient A2. Also, if it is known that “o” comes after “C” and “n” comes after “o”, each pair value is multiplied by a certain coefficient A1 (C+o, o+n, n+s, s+i, i+g, g+n, n+e, e+e, e+“nul”). Then co-efficient A2 is calculated as:

A2=(3+15+14+19+9+7+14+5+5)*B1+(3+15)*A1+(15+14)*A1+(14+19)*A1+(19+9)*A1+(9+7)*A1+(7+14)*A1+(14+5)*A1+(5+5)*A1+(5+0)*A1, where A1=2, B1=30(figures which are derived experimentally and which will vary from case to case).

After that apparatus 100 excludes the missed letter and it's order with OCR results.

=A2−((14+19)*A1+14)−((19+9)*A1+9)

If the difference does not exceed a pre-determined limit (say, 3-5%, which can be variable), apparatus 100 counts this as a matching value; for example if “s” is missed in “Consignee” word, the result would be 3088 (checksum for “Consignee” word from database) and 2961 (for “Conignee” word from OCR, so the difference does not exceed 5% and apparatus 100 counts the word as “Consignee” from a database of words.

It has been found that better results are obtained when using bigger amounts of text, which can also include word order.

This can also be used as a first step of filtration, as other filters may be used—for example if recognised word is used somewhere else in template (like client's name, address or something else—for example if we have other client named CONIGNEE LTD, system still may not return a positive result and flag the matter for an operator's attention.

An overall system flow diagram implementing the optional is illustrated in FIG. 15. Images of the stack of packages have been acquired and are received at the apparatus 1500. Barcode and OCR processing is performed 1502 using the label extraction, logo recognition and up-sample and auto-levelling techniques described above providing raw barcode and OCR data at 1504. Neural data processing is performed at 1508 using the techniques described above, with reference to a logo database 1510. The stack of packages are reconstructed at 1512 as described above, and the reconstructed data for the one or more goods packages is transmitted in XML at 1514.

Referring back to FIG. 1, optional module 117 may also post-process (i.e. “clean”) data from the constructed data model using similar techniques described above with reference to FIG. 14.

As an optional, additional pre-processing methodology, preliminary captured data can also be compared with a customer's ERP data.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

We claim:

1-9. (canceled)

10. Apparatus for constructing a data model of a goods package from a series of images, at least one of the series of images comprising an image of the goods package, the apparatus comprising:
a processor; and
a memory for storing one or more routines which, when executed under control of the processor, control the apparatus:
to extract element data from goods package elements in the series of images; and
to construct the data model by associating element data from a number of visible sides of the goods package with the goods package; and
wherein
the apparatus is configured, under control of the processor to determine the number of visible sides of the goods package by constructing data grids, using the element data, for a plurality of images from the series of images, the goods package being represented in at least one of the data grids and to determine, from the data grids, a number of visible sides of the goods package.

11. The apparatus of claim 10 configured, under control of the processor, to extract goods package element data for a goods package element within one of the series of images by determining element co-ordinates within the image.

12. The apparatus of claim 11 configured, under control of the processor, to determine the element co-ordinates by:
determining, from an image histogram for pixels from one of the series of images, a first maximum intensity value in a first intensity region and a second maximum intensity value in a second intensity region;
determining a minimum intensity value between the first and second maximum intensity values; and
determining the element co-ordinates from an identification of pixels in the image which satisfy a threshold criterion determined with respect to the minimum intensity value.

13. The apparatus of claim 10 configured, under control of the processor, to detect a logo in one of the series of images using edge-based shape detection, and to determine a property of the logo.

14. The apparatus of claim 13 configured, under control of the processor, to determine a parameter of the logo including one or more of: logo type, logo model, logo image co-ordinates, logo angle of orientation, and logo match likelihood score.

15. The apparatus of claim 10 configured, under control of the processor, to construct a preliminary grid of goods packages from element positional data, the preliminary grid of goods packages comprising a grid of the goods package and a second goods package.

16. The apparatus of claim 15 configured, under control of the processor, to construct the preliminary grid of goods packages by defining a grid line between an element of the goods package and a corresponding element of the second goods package.

17. The apparatus of claim 15 configured, under control of the processor, to construct a preliminary grid matrix having a matrix value defining a goods package element type and a goods package element position and correlating the preliminary grid matrix with a template matrix for a match and, in dependence of a match, refining the preliminary grid to define the data grid.

18. The apparatus of claim 10, wherein the data grid comprises a data model derived from an image from the series of images, and the apparatus is configured, under control of the processor, to associate data relating to a goods package in the image with the goods package.

19. The apparatus of claim 18 configured, under control of the processor, to define a data set for a goods package from the element data for the number of visible sides.

20. The apparatus of claim 10 configured, under control of the processor, to analyse a candidate character string read in an OCR process from one of the series of images of the goods package, the apparatus being configured to determine a first distance between the candidate character string and a first dictionary character string from a comparison of a set of candidate character values for the candidate character string and a first set of character values for the first dictionary character string; and to determine, from the comparison, whether the first distance satisfies a comparison criterion.

21. The apparatus of claim 20 configured, under control of the processor, to flag a candidate character string which satisfies the comparison criterion as valid text and to use the valid text in construction of the data model.

22-23. (canceled)

24. A method, implemented in an apparatus, for constructing a data model of a goods package from a series of images, one of the series of images comprising an image of the goods package, the method comprising, under control of a processor of the apparatus:
extracting act element data from goods package elements in the series of images;
constructing the data model by associating element data from a number of visible sides of the goods package with the goods package; and
determining the number of visible sides of the goods package by constructing data grids, using the element data, for a plurality of images from the series of images, the goods package being represented in at least one of the data grids and to determine, from the data grids, a number of visible sides of the goods package.

25-26. (canceled)

27. A machine-readable medium, having stored thereon machine-readable instructions for executing, in a machine, a method for constructing a data model of a goods package from a series of images, one of the series of images comprising an image of the goods package, the method comprising, under control of a processor of the machine:
extracting element data from goods package elements in the series of images;
constructing the data model by associating element data from a number of visible sides of the goods package with the goods package; and
determining the number of visible sides of the goods package by constructing data grids, using the element data, for a plurality of images from the series of images, the goods package being represented in at least one of the data grids and to determine, from the data grids, a number of visible sides of the goods package.

28. The apparatus of claim 20 configured, under control of the processor, to make a determination of whether the candidate character string is a valid character string from a determination of whether the comparison satisfies the comparison criterion.

29. The apparatus of claim 20 configured, under control of the processor, to determine a second distance between the candidate character string and a second dictionary character string from a comparison of the set of candidate character values for the candidate character string and a second set of character values for the second dictionary character string and to determine, from the first and second distances, a likelihood the candidate character string corresponds to one of the first and second dictionary character strings.

30. The apparatus of claim 20 configured, under control of the processor, to select a dictionary character string for a distance determination dependent upon a likelihood the dictionary character string is relevant to the candidate character string.

31. The apparatus of claim 30 configured, under control of the processor, to select the dictionary character string by applying a weighting function selected in dependence of the likelihood the goods package is supplied by a particular supplier.

32. The apparatus of claim 10 configured, under control of the processor, to analyse a barcode read from the image of the goods package by determining a barcode distance between the barcode and a barcode-related character string from a comparison of a set of character values for the barcode and a set of character values for the barcode-related character string and by determining, from the comparison, whether the barcode distance satisfies a barcode comparison criterion.

33. Apparatus according to claim 32 configured, under control of the processor, to select a character string in the image of the goods package as a barcode-related character string dependent upon a location of the character string in the image.
